(19) United States
(12) Patent Application Publication
(10) Pub. No.: US 2014/0379613 A1
(43) Pub. Date: Dec. 25, 2014

(54) INFORMATION PROCESSING DEVICE, INFORMATION PROCESSING SYSTEM, INFORMATION PROCESSING METHOD, AND COMPUTER-READABLE NON-TRANSITORY STORAGE MEDIUM

(71) Applicant: Panasonic Corporation, Osaka (JP)

(72) Inventors: Hiroyuki NISHITANI, Osaka (JP); Toshihiko SATOHIRA, Tokyo (JP); Yoshihiro TABIRA, Osaka (JP); Tomohiro MATSUO, Osaka (JP)

(21) Appl. No.: 14/306,601

(22) Filed: Jun. 17, 2014

(30) Foreign Application Priority Data
Jun. 21, 2013 (JP) 2013-130915
Jun. 21, 2013 (JP) 2013-130929

(51) Int. Cl. G01B 11/02; G06Q 30/02

(52) U.S. Cl. CPC G01B 11/02; G06Q 30/0283
USPC 705/400; 702/155

(57) ABSTRACT

There is provided an information processing device for measuring a dimension of an object to be measured in a low-load calculation processing. A handy terminal includes a depth map sensor block for generating a depth map of an object to be measured by use of a depth map sensor, and a coordinate transformation/side length calculation unit that measures a dimension of the object to be measured based on the depth map. The handy terminal may further includes a delivery fee calculation unit that calculates a delivery fee of the object to be measured based on the dimension.

### CROSS REFERENCE TO RELATED APPLICATIONS

The present application claims the benefits of Patent Application No. 2013-130915 filed in Japan on Jun. 21, 2013 and Patent Application No. 2013-130929 filed in Japan on Jun. 21, 2013, the contents of which are incorporated herein by reference.

### FIELD

The present technique relates to an information processing device for measuring a dimension of an object to be measured, an information processing system, an information processing program, and a recording medium.

### BACKGROUND AND SUMMARY

In recent years, packages handled in delivery services such as home delivery service are increasing along with wide spread of Internet shopping and the like. Conventionally, a dimension of a package to be delivered needed to be manually measured in order to determine a delivery fee of the package to be delivered. Thus, personal costs were high and a processing efficiency in the delivery work was not good.

There is a demand of minimizing the manual works and efficiently performing delivery works. In order to meet the demand, there is known a portable information processing device for shooting a 2D image of a package, performing an image processing on the 2D image to calculate a cubic dimension of the package, and determining a delivery fee based on the cubic dimension (see JP 2003-303222 A, for example).

With the method for calculating a dimension of a package based on a 2D image, however, a package needs to be shot at two mutually-different angles in order to calculate a dimension. The shooting work is complicated for a worker.

Further, the processing of calculating a dimension based on two 2D images has a large processing load and takes a long processing time. Therefore, the calculation processing is difficult to realize in a portable information processing device. In particular, a light and low-power portable information processing device is desired in a field of delivery services, but the demand is difficult to meet for large-load processings.

There is also known a method for calculating a dimension of a package based on one 2D image (e.g., rabatment method). However, in order to calculate 3D information based on a 2D image having only 2D information, a complicated and time-consuming processing such as development or rotation of a graphic is required. Therefore, the method is difficult to realize in a portable information processing device. Further, even if the demand of being light and low-power is met, a dimension calculated based on a 2D image without depth direction information may have a large error.

There is also known a method for calculating a dimension of a package with reference to a size of a slip attached on the package. With the method, however, a dimension measurement error is large, and when a delivery fee is calculated based on the calculate dimension, the error exceeds a permissible limit in the actual delivery service. If an excessively small dimension is calculated, the delivery company is financially damaged, and if an excessively large dimension is calculated, the shipper of the package is financially damaged. Such damages exceed a permissible limit in business, and the method has not reached a practical level.

It is an object of the present technique to provide an information processing device for measuring a dimension of an object to be measured in a low-load calculation processing. It is another object of the present technique to provide an information processing device for highly accurately measuring a dimension of an object to be measured.

An information processing device according to the present technique includes a depth map (range image) generation unit that generates a depth map of an object to be measured by use of a depth map sensor, and a measurement processing unit that measures a dimension of the object to be measured based on the depth map.

An information processing system according to the present technique includes the above information processing device, and the information processing device includes a symbol reader for reading information from a symbol, and the information processing system is configured to associate information read by the symbol reader with a dimension measured by the dimension processing unit.

An information processing system according to the present technique includes the above information processing device, and the information processing device includes a symbol reader for reading information from a symbol, and the information processing system is configured to associate information read by the symbol reader with a dimension measured in the measurement processing unit and/or a delivery fee calculated in a delivery fee calculation unit.

An information processing method according to the present technique includes a depth map generation step of generating a depth map of an object to be measured, and a measurement step of measuring a dimension of the object to be measured based on the depth map.

An information processing method according to the present technique includes a depth map generation step of generating a depth map of an object to be measured, a measurement step of measuring a dimension of the object to be measured based on the depth map, and a delivery fee calculation step of calculating a delivery fee of the object to be measured based on the dimension.

A computer-readable non-transitory storage medium according to the present technique stores therein an information processing program for causing a computer to function as a depth map generation unit that generates a depth map of an object to be measured, and a dimension processing unit that measures a dimension of the object to be measured based on the depth map.

A computer-readable non-transitory storage medium stores therein an information processing program for causing a computer to function as a depth map generation unit that generates a depth map of an object to be measured, a measurement processing unit that measures a dimension of the object to be measured based on the depth map, and a delivery fee calculation unit that calculates a delivery fee of the object to be measured based on the dimension.

According to the present technique, it is possible to measure a dimension of an object to be measured and/or to calculate a delivery fee based thereon at a low load and a high accuracy by generating a depth map of the object to be measured by use of a single depth map acquired by a depth map sensor.

As described later, other forms of the present technique are provided. Therefore, the disclosure of the present technique intends to provide part of the present technique and does not intend to limit the technical scope described and claimed herein.

### BRIEF DESCRIPTION OF DRAWINGS

FIG. 1 is a diagram illustrating a structure of a dimension unit according to a first embodiment of the present technique;

FIG. 2 is a diagram illustrating how an object to be measured is measured by a handy terminal according to the first embodiment of the present technique;

FIG. 3 is a circuit block diagram of the handy terminal according to the first embodiment of the present technique;

FIG. 4 is a diagram illustrating a structure of a depth map sensor block according to the first embodiment of the present technique;

FIG. 5 is a timing chart for explaining how a depth map is generated by the depth map sensor block according to the first embodiment of the present technique;

FIG. 6 is a diagram illustrating an exemplary depth map, and exemplary sides and vertexes detected therefrom according to the first embodiment of the present technique;

FIG. 7 is a diagram illustrating an exemplary display of a screen displayed on a display panel according to the first embodiment of the present technique;

FIG. 8 is a flowchart of measurement by the handy terminal according to the first embodiment of the present technique;

FIG. 9 is a diagram illustrating a structure of an information processing system according to the first embodiment of the present technique;

FIG. 10 is a diagram illustrating a structure of a dimension unit according to a second embodiment of the present technique;

FIG. 11 is a diagram illustrating an exemplary display of a screen displayed on a display panel according to the second embodiment of the present technique; and

FIG. 12 is a flowchart of measurement by a handy terminal according to the second embodiment of the present technique.

### DETAILED DESCRIPTION OF NON-LIMITING EXAMPLE EMBODIMENTS

An information processing device according to embodiments of the present technique will be described below with reference to the accompanying drawings. The embodiments described later are exemplary when the present technique is accomplished, and does not limit the present technique to specific structures described later. A specific structure according to an embodiment may be employed as needed for accomplishing the present technique.

The information processing device according to the present technique includes a depth map generation unit that generates a depth map of an object to be measured by use of a depth map sensor, and a measurement processing unit that measures a dimension of the object to be measured based on the depth map.

With the structure, it is possible to make measurements at a low load and a high accuracy since a depth map of an object to be measured is generated by use of a single depth map acquired by the depth map sensor.

The information processing device may include a vertex detection unit that detects one vertex of an object to be measured and three vertexes adjacent to the one vertex from a depth map, and the measurement processing unit may measure a dimension of the object to be measured by calculating the lengths from the one vertex to the three vertexes, respectively, thereby to measure a dimension of the object to be measured.

With the structure, when a cuboid object is to be measured, the object to be measured can be measured by low-load calculations.

The information processing device may further include a light emission unit that emits a light toward an object to be measured, and may generate a depth map depending on a temporal difference between a timing when a light is emitted from the light emission unit and a light reception signal which is the received light reflected from the object to be measured by the depth map sensor.

With the structure, a depth map can be generated without shooting in a plurality of directions several times, and a depth map can be generated at a low load and high accuracy.

In the information processing device, the depth map generation unit may generate a depth map in the TOF (Time Of Flight) system.

With the structure, a depth map can be generated at a lower load and higher accuracy than in other 3D distance measurement systems such as stereo distance measurement system.

The information processing device may further include a symbol reader for reading information from a symbol, and may associate information read by the symbol reader with a dimension measured by the measurement processing unit.

With the structure, any information on an object to be measured contained in a symbol is associated with a dimension of the object to be measured, thereby managing the object to be measured.

The information processing device may further include a wireless transmission unit that wirelessly transmits a dimension measured by the measurement processing unit.

With the structure, a dimension of an object to be measured can be managed at a remote location.

The information processing device may further include a delivery fee calculation unit that calculates a delivery fee of an object to be measured based on its dimension.

With the structure, a depth map of an object to be measured is generated by use of a single depth map acquired by the depth map sensor, thereby making measurements at low loads and high accuracy.

An information processing system according to the present technique includes the above information processing device, and the information processing device includes a symbol reader for reading information from a symbol, and the information processing system is configured to associate information read by the symbol reader with a dimension measured by the dimension processing unit.

An information processing system according to the present technique includes the above information processing device, and the information processing device includes a symbol reader for reading information from a symbol, and the information processing system is configured to associate information read by the symbol reader with a dimension measured in the measurement processing unit and/or a delivery fee calculated in a delivery fee calculation unit.

With the structure, any information on an object to be measured contained in a symbol is associated with a dimension of the object to be measured and/or a delivery fee calculated by the delivery fee calculation unit, thereby managing the object to be measured.

The information processing device may further include a wireless transmission unit that wirelessly transmits a dimension measured by the measurement processing unit and/or a delivery fee calculated by the delivery fee calculation unit.

With the structure, a dimension and/or a delivery fee of an object to be measured can be managed at a remote location.

An information processing system according to the present technique includes the information processing device, and the information processing device further includes a symbol reader for reading additional information from a symbol and associates information read by the symbol reader with a dimension measured by a measurement processing unit and/or a delivery fee calculated by the delivery fee calculation unit.

With the structure, any information on an object to be measured contained in a symbol is associated with a dimension of the object to be measured and/or a delivery fee calculated by the delivery fee calculation unit, thereby managing the object to be measured.

An information processing method according to the present technique includes a depth map generation step of generating a depth map of an object to be measured, and a measurement step of measuring a dimension of the object to be measured based on the depth map.

Also with the structure, a depth map of an object to be measured is generated by use of a single depth map acquired by the depth map sensor, thereby making measurements at low loads and high accuracy.

An information processing method according to the present technique includes a depth map generation step of generating a depth map of an object to be measured, a measurement step of measuring a dimension of the object to be measured based on the depth map, and a delivery fee calculation step of calculating a delivery fee of the object to be measured based on the dimension.

Also with the structure, a depth map of an object to be measured is generated by use of a single depth map acquired by the depth map sensor, thereby making measurements at low loads and high accuracy.

A computer-readable non-transitory storage medium according to the present technique stores therein an information processing program for causing a computer to function as the depth map generation unit that generates a depth map of an object to be measured, and the measurement processing unit that measures a dimension of the object to be measured based on the depth map.

Also with the structure, a depth map of an object to be measured is generated by use of a single depth map acquired by the depth map sensor, thereby making measurements at low loads and high accuracy.

A computer-readable non-transitory storage medium according to the present technique stores therein an information processing program for causing a computer to function as the depth map generation unit that generates a depth map of an object to be measured, the measurement processing unit that measures a dimension of the object to be measured based on the depth map, and a delivery fee calculation unit that calculates a delivery fee of the object to be measured based on the dimension.

Also with the structure, a depth map of an object to be measured is generated by use of a single depth map acquired by the depth map sensor, thereby making measurements at low loads and high accuracy.

An information storage medium according to the present technique stores the information processing program therein.

Also with the structure, a depth map of an object to be measured is generated by use of a single depth map acquired by the depth map sensor, thereby making measurements at low loads and high accuracy.

### First Embodiment

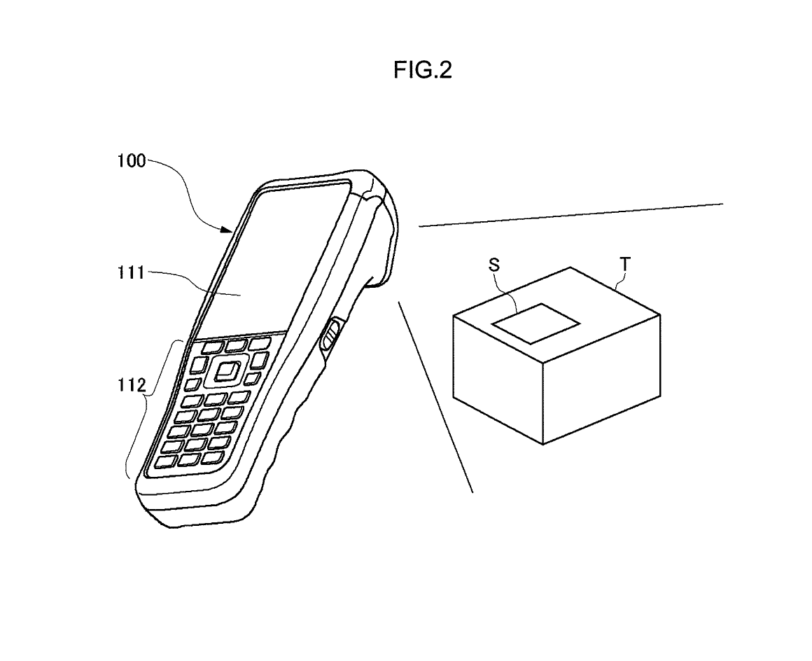

FIG. 2 is a diagram illustrating how an object to be measured is measured by an information processing device according to a first embodiment of the present technique. The information processing device according to the present embodiment is a portable information processing device called handy terminal. A handy terminal 100 is substantially cuboid, includes a display panel 111 at the upper part of the front face, and includes an input key 112 at the lower part of the front face. The display panel 111 is configured of a touch panel. Though not illustrated in FIG. 2, an optical system for depth map shooting or an optical system for barcode scanning is provided on the upper part of the rear face.

An object T to be measure is a cuboid package to be delivered by a delivery service such as home delivery service. Herein, the object T to be measure may be a substantial cuboid such as typical cardboard box for shipping, and is not limited to a perfect cuboid in a mathematical sense. An operator shoots a depth map with the rear face of the handy terminal 100 toward the object T to be measured. The object T to be measured is attached at its surface with a slip S. The slip S denotes therein information on delivery such as slip ID (identification number), delivery destination, delivery source, delivery date and contents, and is coded in barcode of the slip ID. The handy terminal 100 reads the barcode thereby to acquire information on the delivery. The barcode may be a 1D barcode or 2D barcode. The barcode may be coded together with the slip ID in combination of information on delivery such as delivery destination, delivery source, delivery date and contents, and any number of items of information.

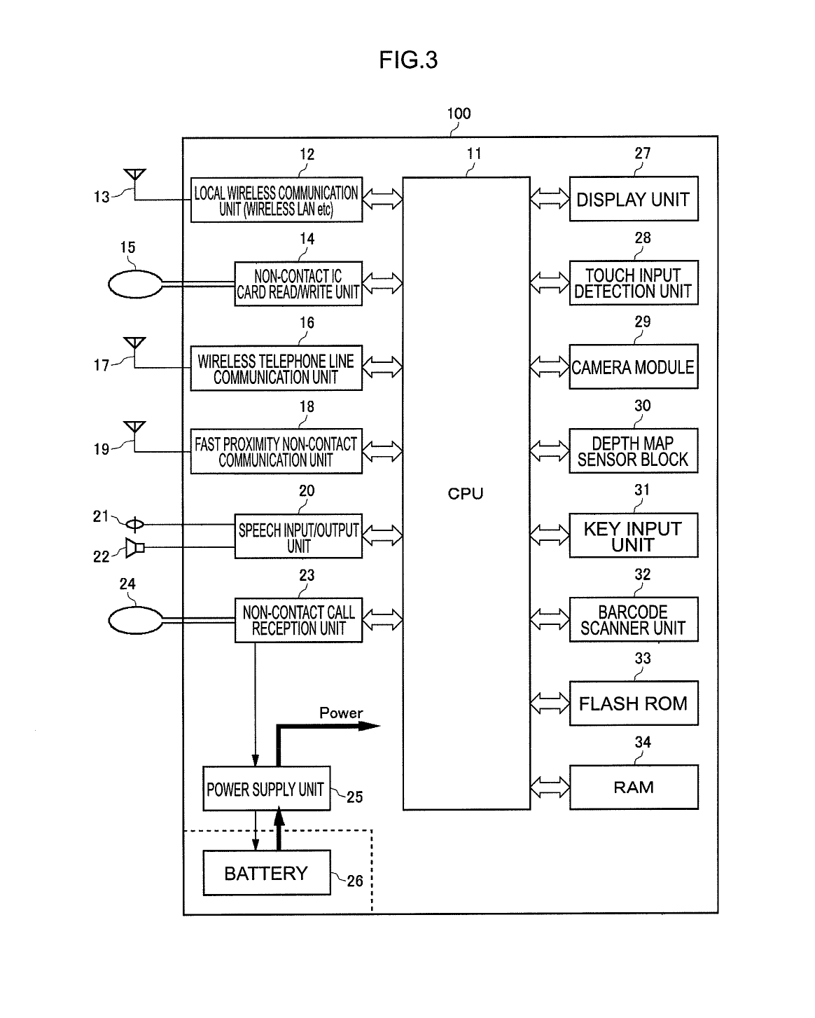

FIG. 3 is a circuit block diagram of the handy terminal. The handy terminal 100 has a CPU 11 as a control unit, and various components are connected to the CPU 11. A local wireless communication unit 12 is connected to a local wireless communication antenna 13, and has a function of making wireless communication by use of a local wireless communication path such as wireless LAN (which may be Bluetooth (trademark) or the like). A non-contact IC card read/write unit 14 is connected to a non-contact IC card communication antenna 15, and has a function of making communication with a non-contact IC card, reading data from the IC card, and writing data into the IC card. A wireless telephone line communication unit 16 is connected to a wireless telephone antenna 17, and has a function of making communication via a wireless telephone line (e.g., cell phone line such as 3G or LTE) (not illustrated).

A fast proximity non-contact communication unit 18 is connected to a fast proximity non-contact communication coupler 19, and has a function of making fast proximity non-contact communication with a network cradle (not illustrated) when the handy terminal 100 is mounted on the network cradle. A speech input/output unit 20 is connected to a microphone 21 and a speaker 22, and has a function of controlling speech input and output. As described above, the handy terminal 100 has the wireless telephone line communication unit 16, and thus is provided with the microphone 21 and the speaker 22 so that it can communicate with other handy terminal, cell phone or land-line phone. Further, when the user operates the handy terminal 100, the speaker 22 can issue a sound for calling for user's attention or an alarm expressing an operation error.

A non-contact power reception unit 23 is connected to a non-contact charging coil 24, and has a function of receiving power from a network cradle when the handy terminal 100 is mounted on the network cradle. A power supply unit 25 is of the handy terminal 100, is supplied with power from a battery 26, and supplies the power to the respective parts of the handy terminal 100 such as the CPU 11. Then, the CPU 11 controls the power supply unit 25 thereby to supply power or stop supplying power to part of or whole circuit configuring the handy terminal 100.

A display unit 27 has a function of controlling the display panel 111 illustrated in FIG. 2. A touch input detection unit 28 has a function of detecting touch input on the display panel 111. A camera module 29 has a function of controlling a camera for shooting. A depth map sensor block 30 has a function of generating a depth map by use of a depth map sensor. A key input unit 31 has a function of receiving inputs from the input key 112 illustrated in FIG. 2. A barcode scanner unit 32 has a function of scanning a barcode and decoding its contents.

The barcode scanner unit 32 is particularly used for reading a barcode indicated in a slip attached on a package as an object to be measured. The barcode contains information (package ID) for specifying a package. The barcode may contain package/delivery information including weight, delivery source, delivery destination, delivery designated time, and in-delivery management temperature (normal, cold, frozen) of a package. Any symbol other than barcode may be denoted on the slip. The barcode scanner unit 32 may also read any other symbol. The barcode scanner unit is an exemplary symbol reader. The camera module 29, the depth map sensor block 30 and the barcode scanner unit 32 may share the same optical system.

A flash ROM 33 has a function of storing various items of data therein. Data to be stored may be data on works, or may be a program for controlling the handy terminal 100. A RAM 34 is a memory employed for temporarily storing processing data generated during a calculation processing and the like along with the operations of the handy terminal 100.

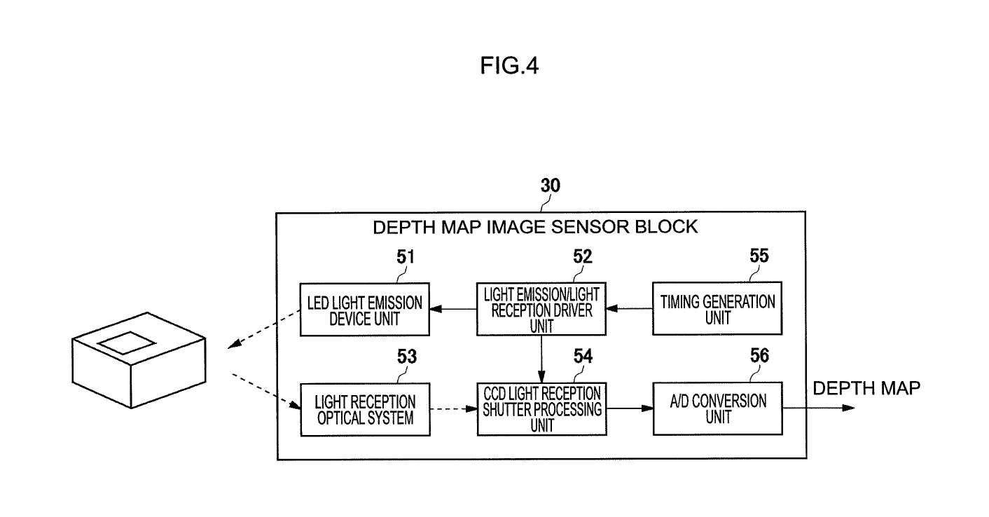

FIG. 4 is a diagram illustrating a structure of the depth map sensor block 30. The depth map sensor block 30 generates a depth map in the TOF (Time Of Flight) system. The depth map sensor block 30 includes a LED light emission device unit 51, a light emission/light reception driver unit 52, a light reception optical system 53, a CCD light reception shutter processing unit 54, a timing generation unit 55 and an A/D conversion unit 56. The LED light emission device unit 51 emits an LED light toward an object T to be measured. A timing and period of the emitted light are controlled by a light emission drive signal generated by the timing generation unit 55. The light emission/light reception driver unit 52 receives a light emission drive signal from the timing generation unit 55 and drives the LED light emission device unit 51 according to the light emission drive signal.

The light reception optical system 53 receives a light which is emitted from the LED light emission device unit 51 and is reflected from the object T to be measured. The CCD light reception shutter processing unit 54 converts the light received by the light reception optical system 53 into an electric signal by CCD. An electronic shutter at this time, or a timing and period for photoelectric conversion by CCD are controlled by an electronic shutter window signal generated by the timing generation unit 55. The light emission/light reception driver unit 52 receives an electronic shutter window signal from the timing generation unit 55, and drives the CCD light reception shutter processing unit 54 according to the electronic shutter window signal. Herein, the electronic shutter is a CCD global shutter, optical shutter or the like, and is not limited thereto.

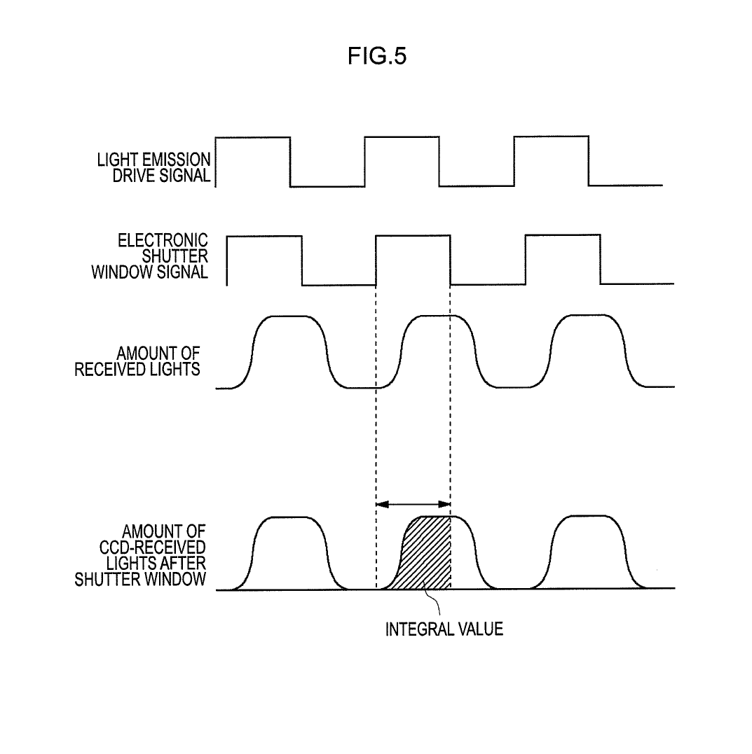

FIG. 5 is a timing chart for explaining how the depth map sensor block 30 generates a depth map. As illustrated in FIG. 5, a light emission drive signal is a pulse wave, and repeats drive (HIGH: light emission) and stop (LOW: light off) at a constant cycle. The amount of actually-emitted lights from the LED does not increase or decrease in response to a light emission drive signal, and smoothly increases and decreases. The electronic shutter window signal is a pulse wave, and repeats drive (HIGH) and stop (LOW) at the same cycle as the light emission drive signal. The light emission drive signal and the electronic shutter window signal may have the same phase, or may be slightly offset in phase from each other (the electronic shutter window signal may be slightly late to the light emission drive signal).

The LED light emission device unit 51 and the CCD light reception shutter processing unit 54 are driven by the light emission drive signal and the electronic shutter window signal, respectively, thereby acquiring the amount of CCD received lights as illustrated in FIG. 5. Herein, when an elapsed time is long, that the elapsed time is from emitting a light of LED light emission device unit 51 until a reflected light of the emitted light is received by the CCD in each pixel, or when the part in the subject captured by the pixel is distant from the information processing device, the amount of reflected lights capable of being received by the CCD is small while the electronic shutter window signal is rising. Conversely, when an elapsed time is short, that the elapsed time is from emitting a light of LED light emission device unit 51 until a reflected light of the emitted light is received by the CCD in each pixel, or when the part in the subject captured by the pixel is near to the information processing device, the amount of reflected lights capable of being received by CCD is large while the electronic shutter window signal is rising.

Therefore, a distance to the part captured by each pixel in the subject can be measured depending on an integral value (or luminance value of each pixel) of the amount of lights received while the light reception shutter window signal is rising in each pixel of the CCD. The light quantity integral value is converted into an electric signal in the CCD, and thus the electric signal indicates a distance to the part captured by each pixel in the subject for each pixel. In this sense, a luminance value of each pixel is distance information indicating a distance. The CCD light reception shutter processing unit 54 outputs the luminance values of all the pixels as a depth map. When a depth map is displayed, a further part in the captured subject is displayed as a lower-density image. A closer part in the captured subject may be displayed as a lower-density image.

As illustrated in FIG. 5, light emission by the LED light emission device unit 51 and photoelectric conversion (integration of the amount of received lights) by the CCD light reception shutter processing unit 54 may be performed several times for generating a single depth map. In this case, a luminance value of each pixel for generating a depth map may be found by averaging the luminance values acquired by light emission and light reception several times and/or employing a median value thereof.

The components except the LED light emission device unit 51 and the light reception optical system 53 among the components of the depth map sensor block 30 illustrated in FIG. 5 correspond to the depth map sensor, and the depth map sensor block 30 corresponds to the depth map generation unit.

Returning to FIG. 4, the A/D conversion unit 56 converts an electric signal (analog signal) output from the CCD light reception shutter processing unit 54 into a digital signal, and outputs a depth map as a digital signal. The depth map is information defining therein a distance to the part captured by each pixel in the subject for each of all the pixels.

The user turns the rear face of the handy terminal 100 toward the object T to be measured and operates the input key 112, thereby shooting a depth map. The depth map is displayed in the preview state on the display panel 111, the user operates the input key 112 for shooting a depth map in this state, and thus a depth map employed for calculating a dimension or the like may be output. The user shoots a depth map of the object to be measured at an angle where the entire cuboid object to be measured is within an image and its three faces are seen.

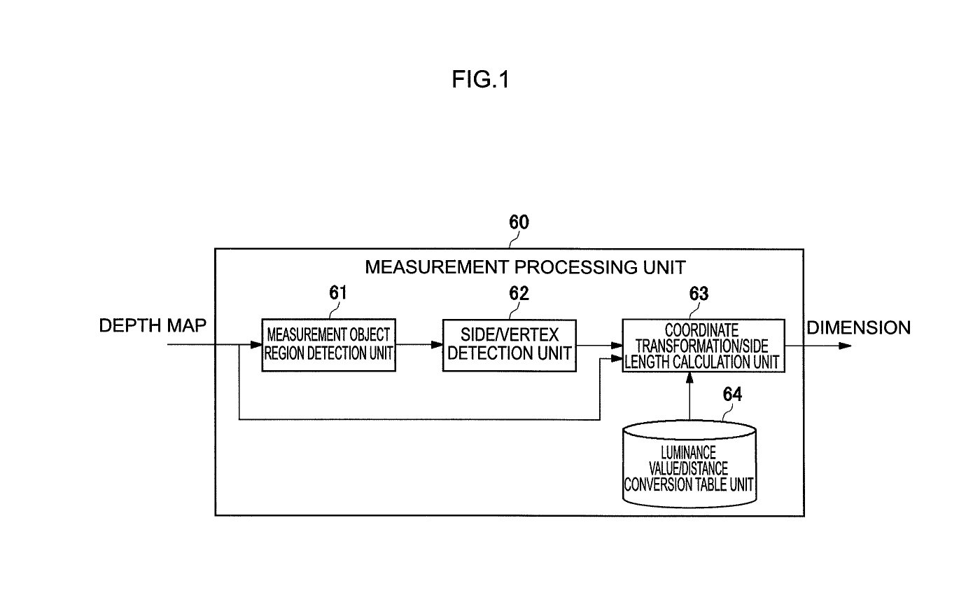

FIG. 1 is a diagram illustrating a structure of the measurement processing unit. The CPU 11 executes the program stored in the flash ROM 33 to perform a calculation processing by use of the RAM 34 so that the structure and function of the measurement processing unit 60 are accomplished. The measurement processing unit 60 calculates a dimension by use of a depth map. The measurement processing unit 60 includes a measurement object region detection unit 61, a side/vertex detection unit 62, a coordinate transformation/side length calculation unit 63, and a luminance value/distance conversion table unit 64.

A depth map generated by the depth map sensor block 30 is input into the measurement processing unit 60. The measurement object region detection unit 61 detects a region of an object to be measured from the input depth map. The side/vertex detection unit 62 detects sides and vertexes from the measurement object region detected by the measurement object region detection unit 61. Herein, the sides can be detected by detecting the edges of the depth map, and the vertexes can be detected by finding the cross points of the sides detected as edges.

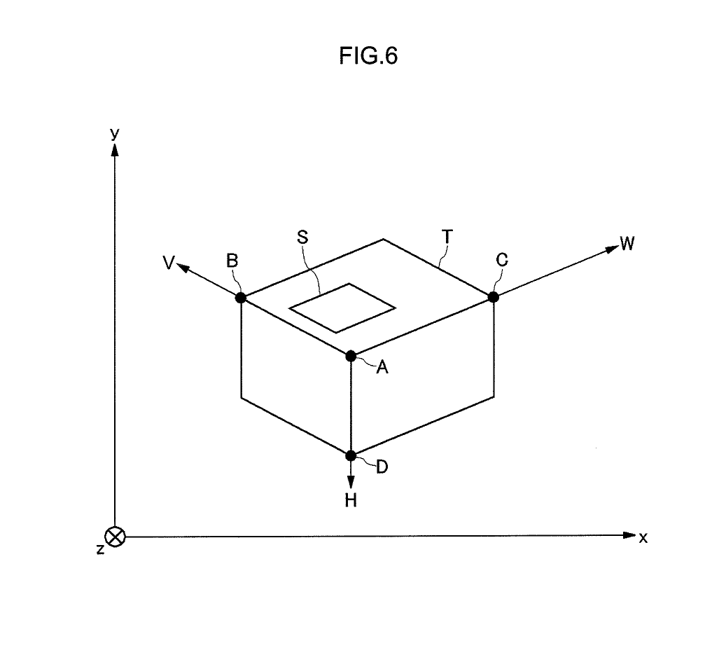

The side/vertex detection unit 62 detects a vertex closest to the information processing device, and detects three adjacent vertexes on a common side with the vertex. FIG. 6 is a diagram illustrating exemplary sides and vertexes detected from a depth map. A depth map has a pixel position and distance information for each pixel. The depth map is 3D shape information on an object to be measured in the depth map space. The 3D shape information is expressed in a viewpoint-based coordinate system (the xyz coordinates in FIG. 6). The closest vertex is point A, and three vertexes adjacent thereto are point B, point C and point D. The side/vertex detection unit 62 detects vertex A, vertex B, vertex C, vertex D, side AB, side AC and side AD. Herein, the vertex A is not limited to the closest vertex to the information processing device, but the closest vertex enables SNR (signal-to-noise ratio) of a reflected light received by the CCD to be high, and a distance detection error to be small.

The coordinate transformation/side length calculation unit 63 inputs information on the sides and vertexes detected by the side/vertex detection unit 62 and the depth map generated by the depth map sensor block 30, thereby transforming the coordinates of the sides and vertexes in the depth map. As described above, the distance information on each pixel in the depth map can be acquired as an integral value (luminance value) of the amount of received lights of the CCD, and thus the coordinate transformation/side length calculation unit 63 first converts the luminance value of a vertex into a distance. For this purpose, the coordinate transformation/side length calculation unit 63 converts a luminance value into a distance with reference to the luminance value/distance conversion table stored in the luminance value/distance conversion table unit 64. Thereby, the depth map has 3D information containing a pixel position (2D) in the viewpoint-based coordinate system and its distances for each pixel.

The coordinate transformation/side length calculation unit 63 performs unit conversion and rotational transformation, specifically affine transformation on the information on the pixel positions and distances of the vertexes. The coordinate transformation/side length calculation unit 63 transforms into a package coordinate system (VWH coordinates in FIG. 6) assuming the closest vertex as the original point, the side AB as depth (vertical) direction (V), the side AC as width direction (W) and the side AD as height direction (H).

The coordinate transformation/side length calculation unit 63 specifically performs coordinate transformation as follows. The pixel positions and distance information (distance information transformed from the luminance values) of the vertexes A, B, C and D are denoted as A=(A_{X}, A_{Y}, A_{Z}), B=(B_{X}, B_{Y}, B_{Z}), C=(C_{X}, C_{Y}, C_{Z}), and D=(D_{X}, D_{Y}, D_{Z}), respectively. Herein, A_{X}, B_{X}, C_{X}, and D_{X} are the x coordinate values in the viewpoint-based coordinate system of the vertexes, respectively, A_{Y}, B_{Y}, C_{Y} and D_{Y} are the y coordinate values in the viewpoint-based coordinate system of the vertexes, respectively, and A_{Z}, B_{Z}, C_{Z} and D_{Z} are the distance values (z coordinate values) in the viewpoint-based coordinate system of the vertexes, respectively.

The coordinate transformation/side length calculation unit 63 transforms the four vertexes in the following equation.

$$( \begin{matrix}{S}_{11} & {S}_{12} & {S}_{13} & {S}_{14} \\ {S}_{21} & {S}_{22} & {S}_{23} & {S}_{24} \\ {S}_{31} & {S}_{32} & {S}_{33} & {S}_{34} \\ {S}_{41} & {S}_{42} & {S}_{43} & {S}_{44}\end{matrix} ) \times ( \begin{matrix}{A}_{X} & {A}_{Y} & {A}_{Z} \\ {B}_{X} & {B}_{Y} & {B}_{Z} \\ {C}_{X} & {C}_{Y} & {C}_{Z} \\ {D}_{X} & {D}_{Y} & {D}_{Z}\end{matrix} ) = ( \begin{matrix}0 & 0 & 0 \\ {B}_{V} & 0 & 0 \\ 0 & {C}_{W} & 0 \\ 0 & 0 & {D}_{H}\end{matrix} )$$

(B_{V} 0, 0), (0, C_{W}, 0), and (0, 0, D_{H}) acquired in the above equation are the coordinates of the vertex B, the vertex C and the vertex D in the package coordinate system (actual space) with the vertex A as the origin, respectively, and B_{V}, C_{W} and D_{H} are the lengths of the side AB, the side AC and the side AD in the real space, respectively. The coordinate transformation/side length calculation unit 63 outputs the calculated lengths B_{V}, C_{W} and D_{H} of the side AB, the side AC and the side AD as a result of the measurement processing. The coordinate transformation/side length calculation unit 63 may output a total length B_{V}+C_{W}+D_{H} of the calculated side AB, side AC and side AD as a result of the measurement processing. The coordinate transformation/side length calculation unit 63 corresponds to the measurement processing unit.

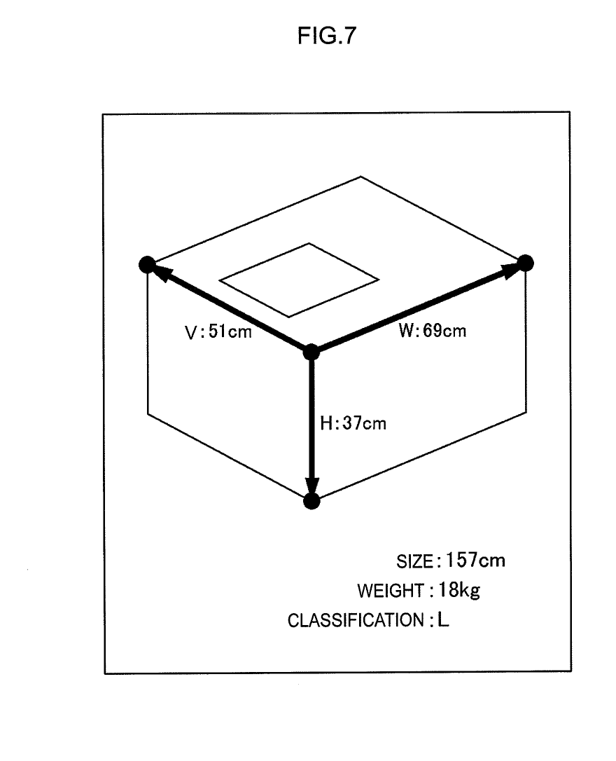

FIG. 7 is a diagram illustrating exemplary display of a screen displayed on the display panel 111 in the handy terminal 100 after a dimension of an object to be measured is calculated in the coordinate transformation/side length calculation unit 63. On the display panel ill, the three sides and the four vertexes detected by the side/vertex detection unit 62 are superimposed on a shot image of a package, and the lengths of the respective sides are displayed. Further, a total length of the respective sides is denoted as a size, and the weight and classification (such as S, M or L) of the package are denoted. Herein, the classification is determined based on the dimension and the weight of the package. The screen display is not limited to information on a calculated dimension of an object to be measured, and an image, sides/vertexes, side lengths, and classification of a package may be sequentially displayed on the screen each time a processing result is acquired.

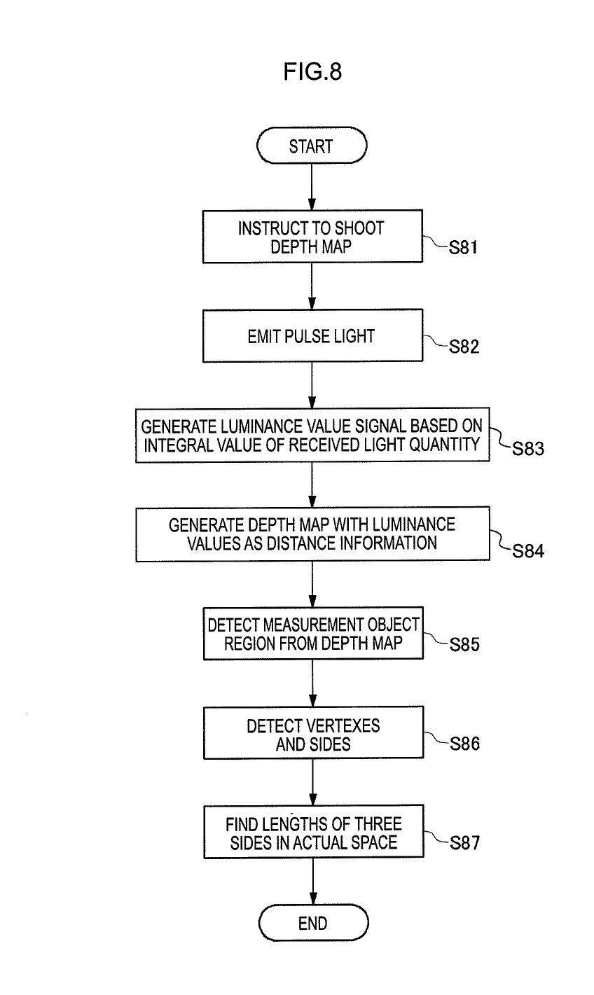

FIG. 8 is a flowchart of measurement in the handy terminal 100. The user instructs to shoot a depth map with the rear face of the handy terminal 100 toward an object to be measured (see FIG. 2) (step S81). The LED light emission device unit 51 is driven at a predetermined pulse width thereby to emit a pulse light (step S82), and the CCD light reception shutter processing unit 54 drives a CCD light reception device at a predetermined pulse width at a predetermined timing synchronized with the pulse light thereby to generate a luminance value signal depending on an integral value of the amount of received lights including the pulse light (step S83). The A/D conversion unit 56 digitally converts the luminance values thereby to generate a depth map with the luminance values as distance information (step S84).

The measurement object region detection unit 61 detects a measurement object region from a depth map (step S85), and the side/vertex detection unit 62 detects the closest vertex and three vertexes adjacent thereto as well as three sides connecting the closest vertex and the three adjacent vertexes (four vertexes in total) from the measurement object region (step S86). The coordinate transformation/side length calculation unit 63 first transforms distance information acquired as luminance values into a values with unit of length for the vertexes detected by the side/vertex detection unit 62, then coordinate-transforms the four vertexes in the depth map into a package coordinate system with the closest vertex as the origin to find the lengths of the three sides in the actual space (step S87).

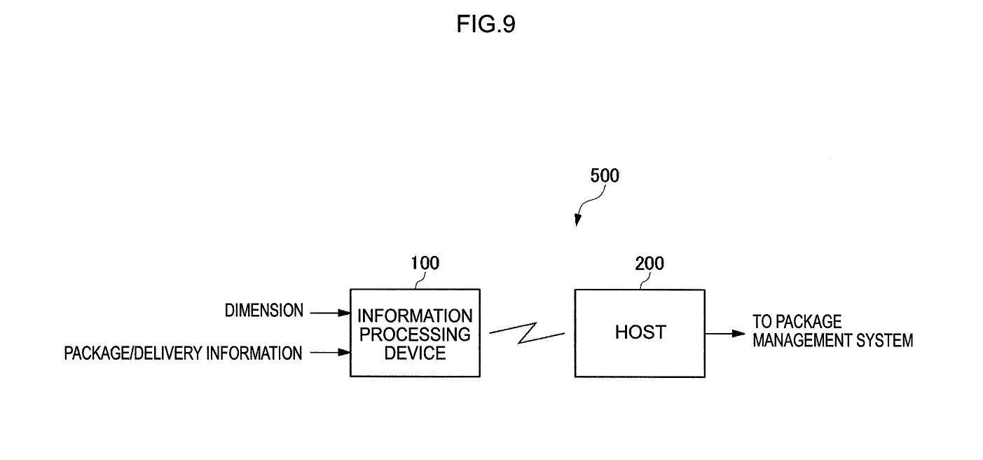

An information processing system including the information processing device will be described below. There will be described herein an example in which an object to be measured is a package. An information processing system 500 according to the embodiment of the present technique is directed for associating information for specifying a package with information on a dimension of the package. FIG. 9 is a diagram illustrating a structure of the information processing system according to the first embodiment of the present technique. The information processing system 500 includes the information processing device (handy terminal) 100 and a host 200. The information processing device 100 can wirelessly communicate various items of information to the host 200. The host 200 can make information communication with a package management system (not illustrated).

The information processing device 100 acquires information (package ID) for specifying a package from a barcode denoted on the package by use of the barcode scanner unit 32. It measures a dimension of the object to be measured with the above structure and operations. Then, the information processing device 100 associates information for specifying a package with information on a dimension of the package and wirelessly transmits them to the host 200. The host 200 transmits the associated information to the package management system so that the package management system can acquire information on a size of a package and can manage the package based on the information. Further, the package/delivery information may be read from the barcode and the package/delivery information may be also associated with the information on package ID and dimension to be transmitted to the host 200.

As a variant, the information may be associated in the host 200. In this case, the host 200 mutually associates other information such as information for specifying a package, information for a dimension of a package and package/delivery information transmitted from the information processing device 100. Also in this way, the package management system can acquire information on a size of a package and can manage a package based on the information.

### Second Embodiment

The information processing device according to a second embodiment of the present technique will be described below with reference to the accompanying drawings. Many parts in the second embodiment are common with those in the first embodiment, and thus a detailed description of the common parts will be omitted.

How the information processing device measures an object to be measured in FIG. 2 is the same as in the first embodiment. The circuit block diagram of the handy terminal illustrated in FIG. 3, the structure of the depth map sensor block 30 illustrated in FIG. 4 and the timing chart for explaining how the depth map sensor block 30 generates a depth map illustrated in FIG. 5 are the same as in the first embodiment.

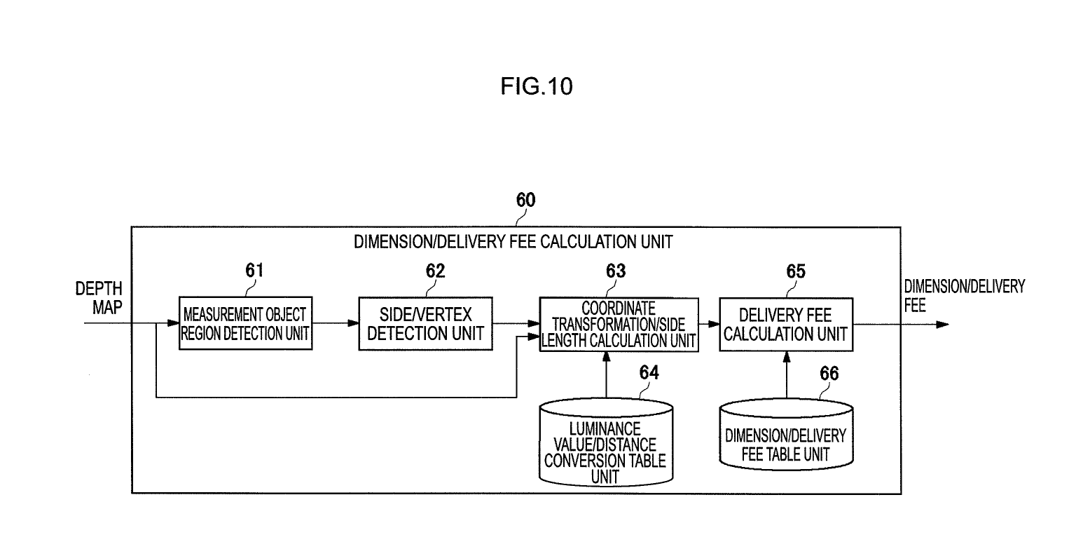

FIG. 10 is a diagram illustrating a structure of a dimension/delivery fee calculation unit. The CPU 11 executes the program stored in the flash ROM 33 and performs the calculation processing by use of the RAM 34 so that the structure and function of the dimension/delivery fee calculation unit 60 are accomplished. The dimension/delivery fee calculation unit 60 calculates a dimension and a delivery fee by use of a depth map. The dimension/delivery fee calculation unit 60 includes the measurement object region detection unit 61, the side/vertex detection unit 62, the coordinate transformation/side length calculation unit 63, the luminance value/distance conversion table unit 64, a delivery fee calculation unit 65 and a dimension/delivery fee table unit 66.

A depth map generated in the depth map sensor block 30 is input into a dimension/delivery fee calculation unit 67. The dimension/delivery fee calculation unit 67 includes the measurement object region detection unit 61, the side/vertex detection unit 62, the coordinate transformation/side length calculation unit 63, and the luminance value/distance conversion table unit 64 similar to the measurement processing unit 60 (see FIG. 1) according to the first embodiment. The measurement object region detection unit 61, the side/vertex detection unit 62, the coordinate transformation/side length calculation unit 63 and the luminance value/distance conversion table unit 64 have the same functions as the processing units with the same names in the first embodiment, respectively.

The delivery fee calculation unit 65 calculates a delivery fee based on the lengths B_{V}, C_{W} and D_{E} of the side AB, the side AC and the side AD. In the present embodiment, the delivery fee calculation unit 65 calculates a delivery fee based on a total length B_{V}+C_{W}+D_{H} of the sides AB, AC and AD. The dimension/delivery fee table unit 66 stores therein a dimension/delivery fee table in which a delivery fee corresponding to a total length of B_{V}+C_{W}+D_{H} is defined. B_{V}×C_{W}×D_{H} may be assumed as a dimension of an object to be measured.

The delivery fee calculation unit 65 finds a delivery fee corresponding to a total length of B_{V}+C_{W}+D_{H} with reference to the dimension/delivery fee table. At this time, the delivery fee calculation unit 65 may calculate a delivery fee also based on package/delivery information including weight, delivery source, delivery destination, delivery designated time, and in-delivery management temperature (normal, cool, frozen) of a package. The package/delivery information may be acquired by reading a barcode attached on a package by the barcode scanner unit 32, and may be acquired via user input into the input key. The information on the lengths of B_{V}, C_{W} and D_{H} of the sides AB, AC and AD and the delivery fee is output from the delivery fee calculation unit 65.

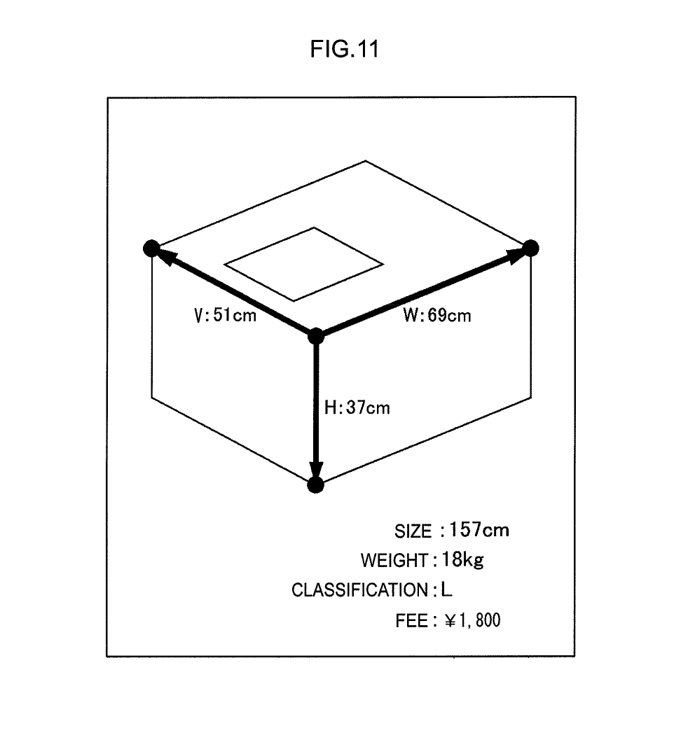

FIG. 11 is a diagram illustrating exemplary display of a screen displayed on the display panel 111 in the handy terminal 100 after a delivery fee is calculated in the delivery fee calculation unit 65. On the display panel 111, three sides and four vertexes detected by the side/vertex detection unit 62 are superimposed on a shot image of a package, and the lengths of the respective sides are displayed. Further, a total length of the respective sides is denoted as a size, and weight, classification (such as S, M or L), fee of the package are denoted. The classification is determined based on a dimension and a weight of a package. The screen display is not limited to information on a calculated dimension of an object to be measured, and an image, sides/vertexes, side lengths, classification, fee of a package may be sequentially displayed on the screen each time a processing result is acquired.

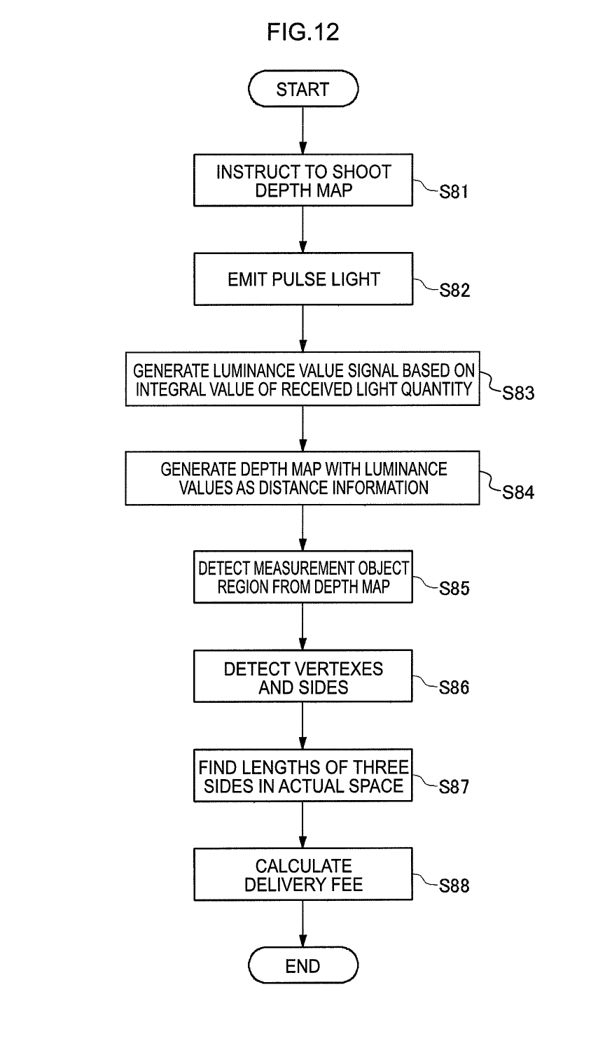

FIG. 12 is a flowchart of measurement and delivery fee calculation in the handy terminal 100. The processings in step S81 to step S87 are the same as those in the flowchart of measurement in the handy terminal 100 illustrated in FIG. 8. Thereafter, the delivery fee calculation unit 65 calculates a delivery fee based on the lengths of three sides calculated in the coordinate transformation/side length calculation unit 63 and, as needed, other package/delivery information (step S88).

An information processing system including the above information processing device will be described below. There will be described herein an example in which an object to be measured is a package. A structure of the information processing system according to the second embodiment of the present technique is the same as the structure of the information processing system according to the first embodiment illustrated in FIG. 9.

The information processing device 100 acquires information (package ID) for specifying a package from a barcode attached on the package by use of the barcode scanner unit 32. A dimension of an object to be measured is measured with the above structure and operations. Then, the information processing device 100 associates information for specifying a package with information on a dimension of the package and wirelessly transmits them to the host 200. The host 200 transmits the associated information to the package management system so that the package management system can acquire information on a size of a package and can manage the package based on the information. Further, package/delivery information may be read from a barcode and the package/delivery information may be transmitted to the host 200 in association with the package ID and the dimension information. Information on package delivery fee may be associated instead of the package dimension information or in addition thereto.

As described above, with the information processing device (handy terminal) according to the first and second embodiments, 3D shape information on an object to be measured (such as package to be delivered) is acquired to make measurements, and thus a dimension of the object to be measured can be measured at a high accuracy. In this way, calculation processing loads are small and consumed power is small, and thus the device is suitably applied to a portable information processing device. The TOF system is employed for acquiring 3D information, and thus the position or angle does not need to be changed for shooting several times and measurements can be made at a higher accuracy.

There has been described the case in which the handy terminal 100 as an information processing device is utilized in a delivery service such as home delivery service according to the first and second embodiments, but the information processing device according to the present technique can be applied to any case in which an object to be measured needs to be measured irrespective of delivery service.

The preferred embodiments according to the present technique conceivable at present have been described above, but various modifications may be made to the present embodiments, and the spirit of the present technique and all the variants within the scope intend to be contained in claims.

A depth map of an object to be measured is generated by use of a single depth map acquired by the depth map sensor, and thus the present technique has an advantage that a depth map can be generated at a low load and high accuracy, and an object to be measured can be measured and a delivery fee can be calculated based on it, and is useful as an information processing device or the like.

What is claimed is:

1. An information processing device comprising:
a depth map generation unit that generates a depth map of an object to be measured by use of a depth map sensor; and
a measurement processing unit that measures a dimension of the object to be measured based on the depth map.

2. The information processing device according to claim 1, further comprising:
a vertex detection unit that detects one vertex of the object to be measured and three vertexes adjacent to the one vertex from the depth map,
wherein the measurement processing unit calculates the lengths from the one vertex to the three vertexes, respectively, thereby to measure a dimension of the object to be measured.

3. The information processing device according to claim 1, further comprising:
a light emission unit that emits a light toward the object to be measured,
wherein the depth map is generated depending on a temporal difference between a timing when a light is emitted from the light emission unit and a light reception signal which is the received light reflected from the object to be measured by the depth map sensor.

4. The information processing device according to claim 1, wherein the depth map generation unit generates the depth map in the TOF (Time Of Flight) system.

5. The information processing device according to claim 1, further comprising:
a symbol reader for reading information from a symbol,
wherein the measurement processing unit associates information read by the symbol reader with a dimension measured by the measurement processing unit.

6. The information processing device according to claim 1, further comprising:
a wireless transmission unit that wirelessly transmits a dimension measured by the measurement processing unit.

7. The information processing device according to claim 1, further comprising:
a delivery fee calculation unit that calculates a delivery fee of the object to be measured based on the dimension.

8. An information processing system comprising the information processing device according to claim 1,
wherein the information processing device includes a symbol reader for reading information from a symbol, and
the information processing system associates information read by the symbol reader with a dimension measured by the dimension processing unit.

9. An information processing system comprising the information processing device according to claim 1,
wherein the information processing device includes a symbol reader for reading information from a symbol, and
the information processing system associates information read by the symbol reader with a dimension measured by the measurement processing unit and/or a delivery fee calculated by the delivery fee calculation unit.

10. An information processing method comprising:
a depth map generation step of generating a depth map of an object to be measured by use of a depth map sensor; and
a measurement step of measuring a dimension of the object to be measured based on the depth map.

11. An information processing method comprising:
a depth map generation step of generating a depth map of an object to be measured by use of a depth map sensor;
a measurement step of measuring a dimension of the object to be measured based on the depth map; and
a delivery fee calculation step of calculating a delivery fee of the object to be measured based on the dimension.

12. A computer-readable non-transitory storage medium having stored therein an information processing program that causes a computer to function as:
a depth map generation unit that generates a depth map of an object to be measured by use of a depth map sensor; and
a measurement processing unit that measures a dimension of the object to be measured based on the depth map.

13. A computer-readable non-transitory storage medium having stored therein an information processing program that causes a computer to function as:
a depth map generation unit that generates a depth map of an object to be measured by use of a depth map sensor;
a measurement processing unit that measures a dimension of the object to be measured based on the depth map; and
a delivery fee calculation unit that calculates a delivery fee of the object to be measured based on the dimension.
